(19) United States
(12) Patent Application Publication
(10) Pub. No.: US 2005/0256801 A1
(43) Pub. Date: Nov. 17, 2005

(54) System and method for processing a transaction

(76) Inventors: Michael Vincent Bucci, Glen Allen, VA (US); William Alan Biggins, Glen Allen, VA (US)

Correspondence Address: Frank M. Gasparo, Esq.;Baker & McKenzie, 29th Floor, 805 Third Avenue, New York, NY, 10022, US

(21) Appl. No.: 10/843,789

(22) Filed: May 11, 2004

(51) Int. Cl. G06F 17/60

(52) U.S. Cl. 705/39; 705/43; 705/42

(57) ABSTRACT

Method for processing a transaction, the method comprising receiving data indicating one of a plurality of personal identification numbers associated with an account holder, each of the plurality of personal identification numbers being associated with a respective one of a plurality of accounts and the one of the plurality of personal identification numbers being entered by the account holder at a point-of-sale terminal, matching the one of the plurality of personal identification numbers with one of the plurality of accounts, and accessing account data corresponding to the one of the plurality of accounts for processing the transaction by the account holder.

### FIELD

The present application relates to a system and method for processing a transaction and, more particularly, to a system and method for processing a transaction according to a personal identification number entered by an account holder.

### BACKGROUND

The creation and functionality of personal identification numbers associated with respective accounts for security purposes are well known in the art. Personal identification numbers are commonly used by financial institutions, such as credit card companies and banks, for authorizing transactions—a transaction initiated with a transaction card of the financial institution is not processed unless the cardholder enters the appropriate, pre-assigned personal identification number at a point-of-sale (“POS”) or at an automated teller machine (“ATM”). If the appropriate personal identification number is entered by the cardholder, the transaction is funded with an account associated with the transaction card, assuming the account has a sufficient balance.

Transaction cards commonly referred to as debit cards are well known in the art. Each of these debit cards has a single pre-defined personal identification number (“PIN”) which must be entered by a respective cardholder for the cardholder to have access to one or more accounts, such as a checking and/or savings account. Thus, upon a cardholder inserting the debit card into a reader of an ATM or upon a magnetic stripe located on the debit card being read at a POS terminal, the cardholder is required to enter the PIN. If the PIN is approved, the cardholder then selects a desired account, possibly from amongst multiple accounts, to fund the particular transaction.

A need exists, however, for a system and method that is operable for a cardholder to select which one of a plurality of accounts to use for a particular transaction at a POS or at an ATM based on the PIN entered by the cardholder at the POS or at the ATM, respectively.

### SUMMARY

An aspect of the present application provides for a method for processing a transaction, the method comprising receiving data indicating one of a plurality of personal identification numbers associated with an account holder, each of the plurality of personal identification numbers being associated with a respective one of a plurality of accounts and the one of the plurality of personal identification numbers being entered by the account holder at a point-of-sale terminal, matching the one of the plurality of personal identification numbers with one of the plurality of accounts, and accessing account data corresponding to the one of the plurality of accounts for processing the transaction by the account holder.

Another aspect of the present application provides for a method for processing a transaction, the method comprising receiving data indicating one of a plurality of personal identification numbers associated with an account holder, each of the plurality of personal identification numbers being associated with a respective one of a plurality of accounts and the one of the plurality of personal identification numbers being entered by the account holder at an automated teller machine, matching the one of the plurality of personal identification numbers with one of the plurality of accounts, and accessing account data corresponding to the one of the plurality of accounts for processing the transaction by the account holder.

A further aspect of the present application provides for a system for processing a transaction, comprising an input device operable for an account holder to enter one of a plurality of personal identification numbers associated with the account holder, each of the plurality of personal identification numbers being associated with a respective one of a plurality of accounts, a memory unit for storing data associated with the plurality of personal identification numbers and the plurality of corresponding accounts, and a determination unit coupled to the input device and the memory unit for determining whether the one of the plurality of personal identification numbers entered at the input device is valid and for matching the one of the plurality of personal identification numbers to one of a plurality of accounts corresponding to the one of the plurality of personal identification numbers by accessing the data stored in the memory unit, if it is determined that the one of the plurality of personal identification numbers is valid.

A still further aspect of the present application provides for a method for conducting a transaction, the method comprising opening a plurality of accounts, assigning a different personal identification number to each of the plurality of accounts, associating each of the plurality of accounts with a transactional card from an issuer, presenting the transaction card to one of a merchant and an automated teller machine, and entering one of the personal identification numbers one of at the merchant and at the automated teller machine to select one of the plurality of accounts used for funding the transaction.

An additional aspect of the present application provides for a system for conducting a transaction, comprising a memory unit for storing data indicating a plurality of personal identification numbers and a plurality of accounts, each of the plurality of personal identification numbers being associated with a respective one of the plurality of accounts, and a processing unit operatively connected to the memory unit, the processing unit programmed to receive data indicating one of the plurality of personal identification numbers associated with an account holder, the one of the plurality of personal identification numbers being entered by the account holder at one of a point-of-sale terminal and an automated teller machine, match the entered one of the plurality of personal identification numbers with a respective one of the plurality of accounts by accessing the stored data indicating the plurality of personal identification numbers, and access account data corresponding to the respective one of the plurality of accounts for processing the transaction by the account holder.

An aspect of the present application provides for a method for processing a transaction, the method comprising receiving data from an account holder indicating a primary account amongst a plurality of accounts, receiving data indicating one of a plurality of personal identification numbers associated with the account holder, each of the plurality of personal identification numbers being associated with at least one account and the one of the plurality of personal identification numbers being entered by the account holder at a point-of-sale terminal, matching the one of the plurality of personal identification numbers with the plurality of accounts, and accessing account data corresponding to the primary account for processing the transaction by the account holder.

Another aspect of the present application provides for a method for processing a transaction, the method comprising receiving data from an account holder indicating a primary account amongst a plurality of accounts, receiving data indicating one of a plurality of personal identification numbers associated with the account holder, each of the plurality of personal identification numbers being associated with at least one account and the one of the plurality of personal identification numbers being entered by the account holder at an automated teller machine, the automated teller machine being unaffiliated with an entity managing the at least one account, matching the one of the plurality of personal identification numbers with the plurality of accounts, and accessing account data corresponding to the primary account for processing the transaction by the account holder.

A further aspect of the present application provides for a system for conducting a transaction, comprising, a memory unit for storing data indicating a plurality of personal identification numbers and a plurality of accounts, each of the plurality of personal identification numbers being associated with at least one account, and a processing unit operatively connected to the memory unit, the processing unit programmed to receive data from an account holder indicating a primary account amongst a plurality of accounts, receive data indicating one of the plurality of personal identification numbers associated with an account holder, the one of the plurality of personal identification numbers being entered by the account holder at one of a point-of-sale terminal and an automated teller machine, the automated teller machine being unaffiliated with an entity managing the at least one account, match the entered one of the plurality of personal identification numbers with the plurality of accounts by accessing the stored data indicating the plurality of personal identification numbers, and access account data corresponding to the primary account for processing the transaction by the account holder.

A still further aspect of the present application provides for a system for conducting a transaction, comprising a memory unit for storing data indicating a plurality of personal identification numbers and a plurality of accounts, each of the plurality of personal identification numbers being associated with at least one account, and a processing unit operatively connected to the memory unit, the processing unit programmed to receive data indicating one of a plurality of personal identification numbers associated with the account holder, the one of the plurality of personal identification numbers being entered by the account holder at an automated teller machine, the automated teller machine being affiliated with an entity managing the at least one account, match the one of the plurality of personal identification numbers with a plurality of accounts, receive selection data from the automated teller machine indicating one of the plurality of accounts, and access account data corresponding to the one of the plurality of accounts for processing the transaction by the account holder.

### BRIEF DESCRIPTION OF THE DRAWINGS

FIG. 1 illustrates an exemplary personal identification number recognition system according to the exemplary embodiments of the present application;

FIG. 2 illustrates in more detail the exemplary system shown in FIG. 1;

FIG. 3 illustrates an exemplary flow diagram for processing a transaction according to a personal identification number entered by an account holder; and

FIG. 4 illustrates an alternative exemplary embodiment according to the exemplary embodiments of the present application.

### DETAILED DESCRIPTION

The exemplary embodiments of the present application are described with reference to an account holder having a plurality of accounts and at least one associated transaction card linked to the plurality of accounts. The account holder can use the card, for example, to make a purchase at or with a merchant and/or can withdraw money from or pay a bill at an ATM, as described in detail herein. The appearance of the transaction card can represent a credit card, a debit card, and an ATM card or the like and, thus, is not meant to be limited to any particular type of card and associated account. As is well known in the art, some transactions can be conducted without presenting a physical card at a POS. Rather, an account holder can present a predetermined number associated with one or more accounts to perform a transaction. Further, transaction cards can be administered by various companies, such as banks, credit card companies, or other institutions or companies.

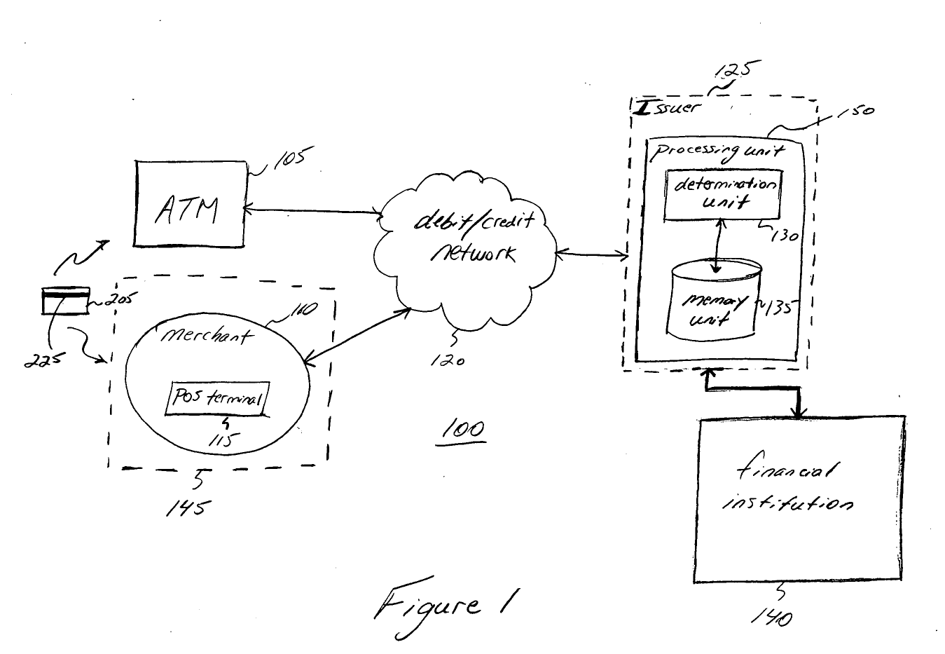

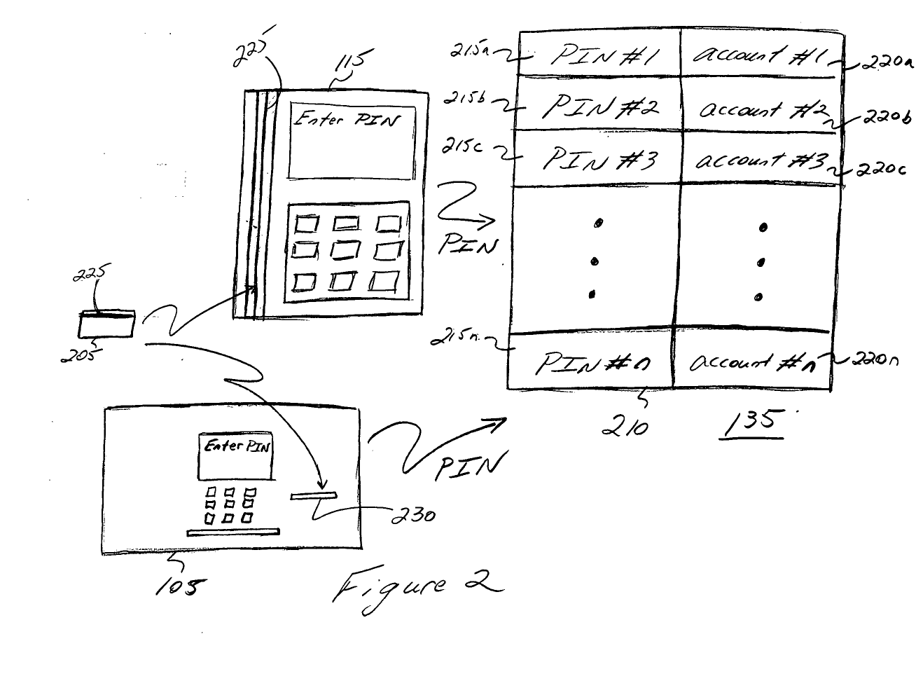

FIG. 1 illustrates an exemplary PIN recognition system 100. PIN recognition system 100 includes input devices, the input devices being, for instance, ATM 105 and POS terminal 115 associated with merchant 110. ATM 105 and POS terminal 115 are coupled to issuer 125 via debit/credit network 120. An account holder can make a purchase at or with merchant 110 using transaction card 205, shown in FIG. 2, and data is transmitted to and from issuer 125 regarding the transaction. Additionally, an account holder can withdraw money from ATM 105 using transaction card 205 and can conduct and transmit other account-related transactions or inquiries, such as bill payments, to issuer 125 via ATM 105. ATM 105 may be associated with issuer 125 or may be associated with a unrelated third party.

Issuer 125 issues to the account holder transaction card 205 and can be a credit card company, a bank, a mortgage company or any other type of financial institution or company. Issuer 125 has associated therewith processing unit 150 including determination unit 130 and memory unit 135; issuer 125 is coupled to financial institution 140, as can be seen in FIG. 1. Like issuer 125, financial institution 140 can be a credit card company, a bank, a mortgage company or any other type of financial institution or company. Memory unit 135 can include various types of memory storage devices, for example, one or more databases, relational or otherwise and, therefore, is not meant to be limited to any particular type of storage device or quantity of storage devices operating alone or in combination.

Debit/credit network 120 can be the MasterCard®/Visa® network or other proprietary networks, such as Plus, Novus (debit), Diner's Club® (credit) and American Express®, the operation and use of which are well known in the art and are, thus, not described herein. Transaction data associated with a transaction between an account holder and merchant 110 is transmitted using debit/credit network 120, as well as transactions by the account holder at ATM 105. Alternatively, transaction data can be transmitted through an Internet link, through a mail link and through a telephone link instead of debit/credit network 120 or in combination with debit/credit network 120, which are not shown in the drawings.

The components of FIG. 1 may be implemented through hardware, software, and/or firmware. The components in PIN recognition system 100 are not limited to those illustrated.

FIG. 2 illustrates in more detail some of the components depicted in FIG. 1. As can be seen in FIG. 2, device 225 and device 230 of POS terminal 115 and ATM 105, respectively, are operable for reading magnetic stripe 225 located on transaction card 205. Various ways of reading magnetic stripes on transaction cards are well known in the art and are, therefore, not described in detail herein. The appearance of transaction card 205 can resemble a credit card, a debit card, an ATM card or the like linked to a plurality of accounts, including, for instance, a checking account, a savings account, a credit account, a money market account and a home equity line of credit account. POS terminal 115 and ATM 105 prompt an account holder to enter a PIN after magnetic stripe 225 is read by device 225 and device 230, respectively, as shown in FIG. 2. Also shown in FIG. 2, memory unit 135 stores table 210. Table 210 stores data associated with a particular account holder that indicates a plurality of PINs 215a . . . 215n and data indicating a plurality of accounts 220a . . . 220n corresponding to the plurality of respective PINs 215a . . . 215n.

For instance, PIN #1 215a corresponds to account #1 220a which could be a checking account, PIN #2 215b corresponds to account #2 220b which could be a savings account, PIN #3 215c corresponds to account #3 220c which could be a money market account and PIN #n 215n corresponds to account #n 220n which could be a home equity line of credit account. At least two of the plurality of accounts 220a . . . 220n can also be the same type of account. The plurality of PINs 215a . . . 215n and the corresponding plurality of accounts 220a . . . 220n can be stored in a table structured differently than table 210 and in a number of different storage formats besides a table, as would be appreciated by a person having ordinary skill in the art. Further, the plurality of PINs 215a . . . 215n can be stored in one memory unit and the corresponding plurality of accounts 220a . . . 220n can be stored in another memory unit, for instance, by using relational databases or otherwise. A separate table for each account holder can be stored in memory unit 135 or data associated with multiple account holders can be stored in the same table.

Issuer 125 issues to the account holder transaction card 205. As is described herein in more detail, depending on which of the plurality of PINs 215a . . . 215n are entered by the account holder after transaction card 205 is read by POS terminal 115 or ATM 105, one of the plurality of corresponding accounts 220a . . . 220n is accessed to process the respective transaction. Each of the plurality of accounts 220a . . . 220n can be managed by issuer 125 and/or financial institution 140.

Upon opening each of the plurality of accounts 220a . . . 220n with issuer 125 or financial institution 140, the account holder is requested to select a PIN having a predetermined amount of letters, numbers or a combination thereof. Each selected PIN corresponding to a respective account, for instance, PINs 215a . . . 215n, is stored in memory unit 135 in association with the corresponding account. PIN(S) 215a . . . 215n can be stored at issuer 125 and/or financial institution 140. As can be seen in FIG. 1, issuer 125 and financial institution 140 are linked such that data can be exchanged for processing transactions by an account holder. The creation of PINs whether automatically generated or personally selected by an account holder are well known in the art and are, therefore, not described in detail herein.

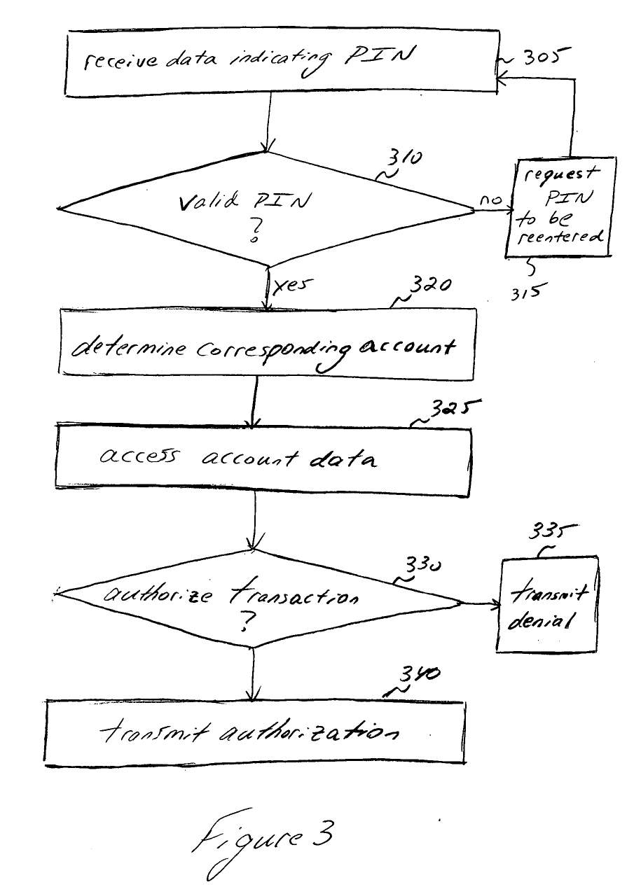

FIG. 3 illustrates an exemplary flow diagram for processing a transaction according to the PIN input by an account holder. At POS 145, the account holder presents transaction card 205 to merchant 110 for funding a transaction. POS terminal 115 and/or one or more other devices electrically coupled thereto read magnetic stripe 225 of transaction card 205. Alternatively, merchant 110 manually inputs into POS terminal 115 or a device electrically coupled thereto a card number embossed, printed or the like on a face of transaction card 205. After magnetic stripe 225 is read and/or after the card number is manually input, POS terminal 115 prompts the account holder to select one of a plurality of options, for instance, a “debit option” or a “credit option”. If the account holder selects an option requiring a PIN, such as the “debit option”, POS terminal 115 then prompts the account holder to input a PIN. As will be appreciated by a person having ordinary skill in the art, the present application is not meant to be limited to the selection of a debit option at a POS terminal in order to prompt an account holder to input a PIN. Rather, other options can be presented which require a PIN input or an account holder can be prompted for a PIN before a POS terminal presents one or more options, if any. At this point, the account holder decides which of the plurality of PINs 215a . . . 215n previously selected by the account holder to be associated with transaction card 205 to enter into POS terminal 115. Depending on which of the plurality of accounts 220a . . . 220n the account holder wants to access for funding the transaction, the account holder enters the corresponding one of the plurality of PINs 215a . . . 215n. For example, if the account holder wants to use account #3 220c to pay for the transaction, then the account holder enters PIN #3 215c.

Issuer 125 receives data from POS terminal 115 associated with merchant 110, and/or from one or more other devices associated with merchant 110, via debit/credit network 120, in 305. The data includes, for example, data identifying the consumer who is associated with transaction card 205 and who has at least one account with issuer 125, and data indicating an amount of the attempted transaction and which of the plurality of PINs 215a . . . 215n entered by the account holder or other individual at POS 145. In 310, determination unit 130 accesses data stored in memory unit 135 to determine whether the entered PIN is valid, for example, by accessing table 210, the data stored therein associated with transaction card 205, and searching for the PIN. If determination unit 130 determines that the entered PIN is not valid, then issuer 125 transmits data to POS terminal 115 indicating that the account holder needs to reenter the PIN, in 315. These steps are repeated until the account holder enters a recognized one of the plurality of PINs 215a . . . 215n that are associated with that account holder. The attempted transaction is terminated, however, if the account holder does not eventually enter a valid one of the plurality of PINs 215a . . . 215n.

Upon determining that a valid PIN was entered by the account holder, in 310, for instance, PIN #3 215c, determination unit 130 determines which one of the plurality of accounts 220a . . . 220n corresponds to PIN #3 215c, in 320. In an exemplary embodiment of the present application, determination unit 130 determines which one of the plurality of accounts 220a . . . 220n corresponds to PIN #3 215c by accessing table 210 stored in memory unit 135 and retrieving data stored in at least one memory location associated with PIN #3 215c. Accordingly, account #3 220c is identified by determination unit 130 as being the corresponding one of the plurality of accounts 220a . . . 220n.

Next, processing unit 150 accesses account data associated with account #3 220c and stored in memory unit 135, in 325. The account data indicates, for instance, a balance if account #3 220c is a deposit account, such as a savings account, a checking account, a money market account or the like, or an open-to-to-buy amount if account #3 220c is a credit account, home equity line of credit account or the like. At least based on the account data associated with account #3 220c, processing unit 150 then determines whether to authorize the attempted transaction by the account holder at POS 145, in 330. For instance, if account #3 220c is a deposit account, then processing unit 150 determines whether the balance of account #3 220c is greater than, equal to or less than the amount of the attempted transaction. Further, if a credit line is associated with the deposit account, for example, overdraft protection, processing unit 150 determines whether an available open-to-buy associated with the deposit account is greater than or equal to the amount of the transaction or a portion of the amount of the transaction not funded by account #3 220c. If account #3 220c is a credit account, then processing unit 150 determines whether an open-to-buy associated with the credit account is greater than or equal to the amount of the attempted transaction.

If a determination is made, in 330, not to authorize the attempted transaction, for example, because the balance and/or credit line is not sufficient, issuer 125 transmits an authorization denial to merchant 110 via debit/credit network 120, in 335. The authorization denial may or may not appear on POS terminal 115 for the account holder to view. On the other hand, if a determination is made, in 330, to authorize the attempted transaction, for example, because the balance and/or credit line is sufficient, issuer 125 transmits data indicating authorization to merchant 110 via debit/credit network 120, in 340. As with an authorization denial, data indicating authorization may or may not appear on POS terminal 115.

In another exemplary embodiment of the present application, an account holder inputs transaction card 205 into ATM 105, for example, for performing a cash withdrawal. ATM 105 reads magnetic stripe 225 of transaction card 205. After magnetic stripe 225 is read, ATM 105 prompts the account holder to enter a PIN. The account holder then decides which of the plurality of PINs 215a . . . 215n previously selected by the account holder to be associated with transaction card 205 to enter into ATM 105. Depending on which of the plurality of accounts 220a . . . 220n the account holder wants to use to fund the cash withdrawal, the account holder enters the corresponding one of the plurality of PINs 215a . . . 215n. Since in this exemplary embodiment the entered PIN is associated with one of the plurality of accounts 220a . . . 220n, that account will be used to fund the cash withdrawal regardless of which selection the account holder makes at ATM 105, for instance, regardless whether the account holder selects a “checking account” option or a “savings account” option. The attempted transaction is processed in the same manner as described above with reference to step 305 through step 340 shown in FIG. 3.

If ATM 105 is associated with issuer 125 and/or financial institution 140, ATM 105 will display data pertaining only to the associated one of the plurality of accounts 220a . . . 220n after transaction card 205 is read and one of the plurality of PINs 215a . . . 215n is entered. If ATM 105 is associated with an unrelated third party, ATM 105 will display general data referring to one or more types of accounts, even though the entered PIN is associated with only one of the plurality of accounts 220a . . . 220n and even though regardless which account selection the account holder makes the same account will be used to fund the cash withdrawal. Alternatively, ATM 105 will display data pertaining to a plurality of accounts 220a . . . 220n of the account holder or data pertaining only to the associated one of the plurality of accounts 220a . . . 220n.

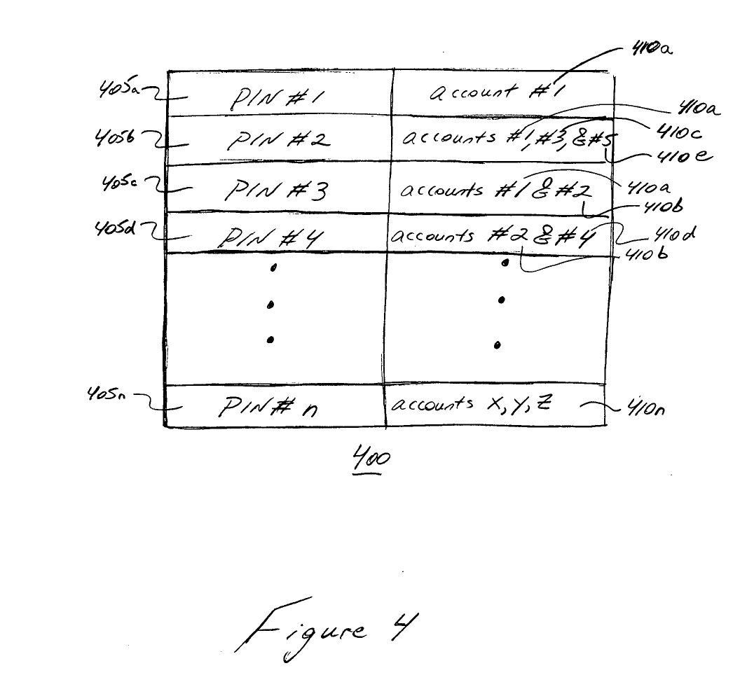

As can be seen in FIG. 4, in another exemplary embodiment of the present application, each of a plurality of PINs 405a . . . 405n are associated with one or more accounts. Specifically, like table 210 described herein, memory unit 135 stores table 400. Table 400 stores data associated with a particular account holder that indicates a plurality of PINs 405a . . . 405n and data indicating a plurality of accounts 410a . . . 410n corresponding to one or more of the plurality of 405a . . . 405n.

For instance, PIN #1 405a corresponds to account #1 410a, PIN #2 405b corresponds to multiple accounts—account #1 410a, account #3 410c and account #5 410e, PIN #3 410c also corresponds to multiple accounts—account #1 410a and account #2 410b, PIN #4 405d corresponds to multiple accounts—account #2 410b and account #4 410d and PIN #n 405n corresponds to accounts x, y, z 410n.

At least two of the plurality of accounts 410a . . . 410n can also be the same type of account. The plurality of PINs 405a . . . 405n and the corresponding account(s) can be stored in a table structured differently than table 400 and in a number of different storage formats besides a table, as would be appreciated by a person having ordinary skill in the art. Further, the plurality of PINs 405a . . . 405n can be stored in one memory unit and the corresponding account(s) can be stored in another memory unit, for instance, by using relational databases or otherwise. A separate table for each account holder can be stored in memory unit 135 or data associated with multiple account holders can be stored in the same table.

In an exemplary embodiment, in the event that a PIN, for example, PIN #2, is associated with a plurality of accounts (account #1 410a, account #3 410c and account #5 410e), the account holder selects which of those accounts to be designated as a primary account. The primary account designation is utilized by processing unit 150 when the account holder enters, for example, PIN #2 at POS terminal 115 or at ATM 105, if ATM 105 is associated with an unrelated third party. In particular, at POS terminal 115, after magnetic stripe 225 is read and/or after the card number is manually input, POS terminal 115 prompts the account holder to select one of a plurality of options, for instance, a “debit option” or a “credit option”. If the account holder selects an option requiring a PIN, such as the “debit option”, POS terminal 115 then prompts the account holder to input a PIN. At this point, the account holder decides which of the plurality of PINs 405a . . . 405n previously selected by the account holder to be associated with transaction card 205 to enter into POS terminal 115. If the account holder wants to access the previously designated primary account amongst accounts #1 410a, #3 410c and #5 410e, for example, account #1 410a, the account holder enters PIN #2 405b. The attempted transaction is processed in the same manner as described above with reference to step 305 through step 340 shown in FIG. 3.

Further, at ATM 105, if ATM 105 is associated with an unrelated third party, after the account holder enters one of the plurality of PINs 405a . . . 405n (e.g., PIN #2 405b), ATM 105 will display general data referring to one or more types of accounts, even though the entered PIN is associated with only one of the plurality of accounts 410a . . . 410b and even though regardless which account selection the account holder makes the same previously designated primary account will be used to fund the cash withdrawal. Alternatively, ATM 105 will display data pertaining to a plurality of accounts 410a . . . 410b of the account holder or data pertaining only to the associated one of the plurality of accounts previously designated as the primary account.

On the other hand, after the account holder enters one of the plurality of PINs 405a . . . 405n, if ATM 105 is associated with issuer 125 and/or financial institution 140, ATM 105 will display data pertaining only to the one or more accounts associated with the entered PIN. For example, if the account holder inputs PIN #4 at ATM 105, then ATM 105 will display data which provides the account holder an option of selecting account #2 410b or account #4 410 to fund the cash withdrawal. The attempted transaction is processed in the same manner as described above with reference to step 305 through step 340 shown in FIG. 3. As will be appreciated by a person having ordinary skill in the art, the present application is not limited to input devices such as POS terminals and ATMs. Rather, any system or device receptive of a user PIN input can be used to implement the exemplary embodiments of the present application, for instance, an automated voice response unit or the like, a web page or other interface on a personal computer, a cellular telephone, a personal digital assistant or other wireless device. Furthermore, the present application is not limited to transmitting data via debit/credit network 120. Data can also be transmitted via the Internet, via telephone or via one or more other communication links, whether land-line or wireless.

In an exemplary embodiment, one or more of the plurality of accounts 220a . . . 220n can be managed by financial institution 140 instead of or in conjunction with issuer 125. As can be seen in FIG. 1, financial institution 140 is coupled to issuer 125 for the transmission of data to and from issuer 125. In an exemplary embodiment, an account holder could open an account with financial institution 140, for example, account #2 220b, and assign a PIN to that account, PIN #2 215b. The account holder would thereafter provide to issuer 125 data pertaining to financial institution 140 and to account #2 220b including, for instance, PIN #2 215b. As a result, when issuer 125 receives data from merchant 110 or automated teller machine 105 indicating PIN #2 215b was entered by the account holder, determination unit 130 recognizes that financial institution 140 needs to be contacted to authorize the transaction using account #2 220b. Alternatively, financial institution 140 can continuously transmit updated information, such as balance information and information indicating the current open-to-buy, to issuer 125 so that data associated with account #2 220b and stored in memory unit 135 remains current.

The exemplary embodiments of the present application were described and illustrated herein with reference to a plurality of PINs 215a . . . 215n. The present application, however, is not meant to be limited to PINS. Rather, any predetermined or automatically generated number, code or the like can be associated with an account and used as the plurality of PINs 215a . . . 215n are described as being used in accordance with the exemplary embodiments of the present application.

The embodiments described above are illustrative examples of the present application and it should not be construed that the present application is limited to these particular embodiments. Various changes and modifications may be effected by one skilled in the art without departing from the spirit or scope of the invention as defined in the appended claims.

1. A method for processing a transaction, the method comprising:
receiving data indicating one of a plurality of personal identification numbers associated with an account holder, each of the plurality of personal identification numbers being associated with a respective one of a plurality of accounts and the one of the plurality of personal identification numbers being entered by the account holder at a point-of-sale terminal;
matching the one of the plurality of personal identification numbers with one of the plurality of accounts; and
accessing account data corresponding to the one of the plurality of accounts for processing the transaction by the account holder.

2. The method as set forth in claim 1, wherein
matching the one of the plurality of personal identification numbers includes
accessing a table stored in a memory unit to determine which of the plurality of accounts is associated with the one of plurality of personal identification numbers entered by the account holder.

3. The method as set forth in claim 1, wherein
matching the one of the plurality of personal identification numbers includes
accessing a table stored in a memory unit for verifying the one of the plurality of personal identification numbers entered by the account holder is valid, and
determining from the table which of the plurality of accounts is associated with the one of plurality of personal identification numbers entered by the account holder, if the one of the plurality of personal identification numbers is valid.

4. The method as set forth in claim 1, wherein
the plurality of accounts include at least two of a checking account, a savings account, a money market account, a home equity line of credit account and a credit card account.

5. A method for processing a transaction, the method comprising:
receiving data indicating one of a plurality of personal identification numbers associated with an account holder, each of the plurality of personal identification numbers being associated with a respective one of a plurality of accounts and the one of the plurality of personal identification numbers being entered by the account holder at an automated teller machine;
matching the one of the plurality of personal identification numbers with one of the plurality of accounts; and
accessing account data corresponding to the one of the plurality of accounts for processing the transaction by the account holder.

6. The method for processing a transaction as set forth in claim 5, wherein
the automated teller machine is affiliated with an entity managing the one of the plurality of accounts.

7. The method for processing a transaction as set forth in claim 6, further comprising:
displaying data indicating only the one of the plurality of accounts on a display of the automated teller machine for the account holder to select the one of the plurality of accounts.

8. The method for processing a transaction as set forth in claim 5, wherein
the automated teller machine is unaffiliated with an entity managing the one of the plurality of accounts.

9. The method as set forth in claim 5, wherein
matching the one of the plurality of personal identification numbers includes
accessing a table stored in a memory unit to determine which of the plurality of accounts is associated with the one of plurality of personal identification numbers entered by the account holder.

10. The method as set forth in claim 5, wherein
matching the one of the plurality of personal identification numbers includes
accessing a table stored in a memory unit for verifying the one of the plurality of personal identification numbers entered by the account holder is valid, and
determining from the table which of the plurality of accounts is associated with the one of plurality of personal identification numbers entered by the account holder, if the one of the plurality of personal identification numbers is valid.

11. The method as set forth in claim 5, wherein
the plurality of accounts include at least two of a checking account, a savings account, a money market account, a home equity line of credit account and a credit card account.

12. A system for processing a transaction, comprising:
an input device operable for an account holder to enter one of a plurality of personal identification numbers associated with the account holder, each of the plurality of personal identification numbers being associated with a respective one of a plurality of accounts,
a memory unit for storing data associated with the plurality of personal identification numbers and the plurality of corresponding accounts; and
a determination unit coupled to the input device and the memory unit for determining whether the one of the plurality of personal identification numbers entered at the input device is valid and for matching the one of the plurality of personal identification numbers to one of a plurality of accounts corresponding to the one of the plurality of personal identification numbers by accessing the data stored in the memory unit, if it is determined that the one of the plurality of personal identification numbers is valid.

13. The system as set forth in claim 12, wherein
the memory unit includes at least one table, the at least one table storing the data.

14. The system as set forth in claim 12, wherein
the input device is a point-of-sale terminal.

15. The system as set forth in claim 12, wherein
the input device is an automated teller machine.

16. A method for conducting a transaction, the method comprising:
opening a plurality of accounts;
assigning a different personal identification number to each of the plurality of accounts;
associating each of the plurality of accounts with a transactional card from an issuer;
presenting the transaction card to one of a merchant and an automated teller machine; and
entering one of the personal identification numbers one of at the merchant and at the automated teller machine to select one of the plurality of accounts used for funding the transaction.

17. A system for conducting a transaction, comprising:
a memory unit for storing data indicating a plurality of personal identification numbers and a plurality of accounts, each of the plurality of personal identification numbers being associated with a respective one of the plurality of accounts; and
a processing unit operatively connected to the memory unit, the processing unit programmed to
receive data indicating one of the plurality of personal identification numbers associated with an account holder, the one of the plurality of personal identification numbers being entered by the account holder at one of a point-of-sale terminal and an automated teller machine,
match the entered one of the plurality of personal identification numbers with a respective one of the plurality of accounts by accessing the stored data indicating the plurality of personal identification numbers, and
access account data corresponding to the respective one of the plurality of accounts for processing the transaction by the account holder.

18. A method for processing a transaction, the method comprising:
receiving data from an account holder indicating a primary account amongst a plurality of accounts;
receiving data indicating one of a plurality of personal identification numbers associated with the account holder, each of the plurality of personal identification numbers being associated with at least one account and the one of the plurality of personal identification numbers being entered by the account holder at a point-of-sale terminal;
matching the one of the plurality of personal identification numbers with the plurality of accounts; and
accessing account data corresponding to the primary account for processing the transaction by the account holder.

19. The method as set forth in claim 18, wherein
matching the one of the plurality of personal identification numbers includes
accessing a table stored in a memory unit to determine the at least one account associated with the one of plurality of personal identification numbers entered by the account holder.

20. The method as set forth in claim 18, wherein
matching the one of the plurality of personal identification numbers includes
accessing a table stored in a memory unit for verifying the one of the plurality of personal identification numbers entered by the account holder is valid, and
determining from the table the at least one account associated with the one of plurality of personal identification numbers entered by the account holder, if the one of the plurality of personal identification numbers is valid.

21. The method as set forth in claim 18, wherein
the plurality of accounts include at least two of a checking account, a savings account, a money market account, a home equity line of credit account and a credit card account.

22. A method for processing a transaction, the method comprising:
receiving data from an account holder indicating a primary account amongst a plurality of accounts;
receiving data indicating one of a plurality of personal identification numbers associated with the account holder, each of the plurality of personal identification numbers being associated with at least one account and the one of the plurality of personal identification numbers being entered by the account holder at an automated teller machine, the automated teller machine being unaffiliated with an entity managing the at least one account;
matching the one of the plurality of personal identification numbers with the plurality of accounts; and
accessing account data corresponding to the primary account for processing the transaction by the account holder.

23. The method as set forth in claim 22, wherein
matching the one of the plurality of personal identification numbers includes
accessing a table stored in a memory unit to determine the at least one account associated with the one of plurality of personal identification numbers entered by the account holder.

24. The method as set forth in claim 22, wherein
matching the one of the plurality of personal identification numbers includes
accessing a table stored in a memory unit for verifying the one of the plurality of personal identification numbers entered by the account holder is valid, and
determining from the table the at least one account associated with the one of plurality of personal identification numbers entered by the account holder, if the one of the plurality of personal identification numbers is valid.

25. The method as set forth in claim 22, wherein
the plurality of accounts include at least two of a checking account, a savings account, a money market account, a home equity line of credit account and a credit card account.

26. A method for processing a transaction, the method comprising:
receiving data indicating one of a plurality of personal identification numbers associated with the account holder, each of the plurality of personal identification numbers being associated with at least one account and the one of the plurality of personal identification numbers being entered by the account holder at an automated teller machine, the automated teller machine being affiliated with an entity managing the at least one account;
matching the one of the plurality of personal identification numbers with a plurality of accounts;
receiving selection data from the automated teller machine indicating one of the plurality of accounts; and
accessing account data corresponding to the one of the plurality of accounts for processing the transaction by the account holder.

27. The method for processing a transaction as set forth in claim 26, further comprising:
displaying data indicating the plurality of accounts on a display of the automated teller machine for the account holder to select the one of the plurality of accounts.

28. The method as set forth in claim 26, wherein
matching the one of the plurality of personal identification numbers includes
accessing a table stored in a memory unit to determine the plurality of accounts associated with the one of plurality of personal identification numbers entered by the account holder.

29. The method as set forth in claim 26, wherein
matching the one of the plurality of personal identification numbers includes
accessing a table stored in a memory unit for verifying the one of the plurality of personal identification numbers entered by the account holder is valid, and
determining from the table the plurality of accounts associated with the one of plurality of personal identification numbers entered by the account holder, if the one of the plurality of personal identification numbers is valid.

30. The method as set forth in claim 26, wherein
the plurality of accounts include at least two of a checking account, a savings account, a money market account, a home equity line of credit account and a credit card account.

31. A system for conducting a transaction, comprising:
a memory unit for storing data indicating a plurality of personal identification numbers and a plurality of accounts, each of the plurality of personal identification numbers being associated with at least one account; and
a processing unit operatively connected to the memory unit, the processing unit programmed to
receive data from an account holder indicating a primary account amongst a plurality of accounts,
receive data indicating one of the plurality of personal identification numbers associated with an account holder, the one of the plurality of personal identification numbers being entered by the account holder at one of a point-of-sale terminal and an automated teller machine, the automated teller machine being unaffiliated with an entity managing the at least one account,
match the entered one of the plurality of personal identification numbers with the plurality of accounts by accessing the stored data indicating the plurality of personal identification numbers, and
access account data corresponding to the primary account for processing the transaction by the account holder.

32. A system for conducting a transaction, comprising:
a memory unit for storing data indicating a plurality of personal identification numbers and a plurality of accounts, each of the plurality of personal identification numbers being associated with at least one account; and
a processing unit operatively connected to the memory unit, the processing unit programmed to
receive data indicating one of a plurality of personal identification numbers associated with the account holder, the one of the plurality of personal identification numbers being entered by the account holder at an automated teller machine, the automated teller machine being affiliated with an entity managing the at least one account,
match the one of the plurality of personal identification numbers with a plurality of accounts,
receive selection data from the automated teller machine indicating one of the plurality of accounts, and
access account data corresponding to the one of the plurality of accounts for processing the transaction by the account holder.
